(19) United States
(12) Patent Application Publication
(10) Pub. No.: US 2006/0047714 A1
(43) Pub. Date: Mar. 2, 2006

(54) Systems and methods for rapid presentation of historical views of stored data

(75) Inventors: Curtis Anderson, Saratoga, CA (US); John P. Woychowski, San Jose, CA (US); Pratik Wadher, Sunnyvale, CA (US); Balaji Narasimhan, Los Altos, CA (US)

Correspondence Address: CARR & FERRELL LLP, 2200 GENG ROAD, PALO ALTO, CA, 94303, US

(73) Assignee: Mendocino Software, Inc.

(21) Appl. No.: 11/216,874

(22) Filed: Aug. 30, 2005

Related U.S. Application Data
(60) Provisional application No. 60/605,168, filed on Aug. 30, 2004.

(51) Int. Cl. G06F 17/30

(52) U.S. Cl. 707/202

(57) ABSTRACT

A system and method is provided for systems and methods for rapid presentation of historical views of stored data. In a method for rapid presentation of historical views, a request for a historical view of stored data is received. An index that indicates the location of at least one data block copy in a storage medium that correlates with the historical view is accessed and the at least one data block copy from the storage medium is retrieved. The historical view of the stored data is then generated from the at least one data block copy.

### CROSS-REFERENCE TO RELATED APPLICATIONS

The present application claims the benefit and priority of U.S. provisional patent application Ser. No. 60/605,168, filed on Aug. 30, 2004, and entitled “Image Manipulation of Data,” which is herein incorporated by reference.

The present application is related to co-pending U.S. application Ser. No. ______ entitled “Systems and Methods for Organizing and Mapping Data,” filed on Jun. 23, 2005, co-pending U.S. application Ser. No. ______,“Systems and Methods for Event Driven Recovery Management”, filed on Aug. 30, 2005, co-pending U.S. application Ser. No. ______, entitled “Protocol for Communicating Data Block Copies in an Error Recovery Environment”, filed on Aug. 30, 2005, and co-pending U.S. application co-pending U.S. application Ser. No. ______, entitled “Systems and Methods of Optimizing Restoration of Stored Data”, filed Aug. 30, 2005, which are herein incorporated by reference.

### BACKGROUND OF THE INVENTION

1. Field of the Invention

The present invention relates generally to recovery management, and more particularly to systems and methods for rapid presentation of historical views of stored data.

2. Description of Related Art

Conventionally, recovery management has been overseen by various systems that keep track of data being written to a storage medium. Recovery management may be necessary to recover data that has been altered by a disk crash, a virus, erroneous deletions, overwrites, and so on. Numerous other reasons are cited by companies and individuals for requiring access to data as it existed at one point in time.

Back-up methods for storing data are necessary before the data can be recovered. Back-up methods may include the activity of copying files or databases so that they will be preserved in case of equipment failure or other catastrophe. Some processes may involve copying back-up files from back-up media to hard disk in order to return data to its original condition. Other techniques may include an ability to periodically copy contents of all or a designated portion of data from the data's main storage device to a cartridge device so the data will not be lost in the event of a hard disk crash.

Back-up procedures, such as those described above, require a great deal of processing power from the server performing the back-ups. For this reason, back-up procedures may be offloaded from a server so that the time ordinarily devoted to back-up functions can be used to carry out other server tasks. For example, in some environments, an intelligent agent may be utilized to offload the back-up procedures. The intelligent agent may take a “snapshot” of a computer's data at a specific time so that if future changes cause a problem, the system and data may be restored to the way they were before the changes were made.

Once copies of the data have been made in some manner, data recovery may be utilized to recover the data using the copies. Data recovery seeks to return the data to a state before particular changes were made to the data. Thus, the data may be recovered to different points in time, depending upon the state of the data a user may want to access. However, locating the data to the different points in time can be a long and arduous process.

The user may utilize the recovered data for a variety of tasks, such as studying the data to determine possible causes of software program errors or bugs. However, different users often cannot readily locate and utilize data recovered from other users. Further, determining how data created by other users may relate to other data is frequently a difficult or impossible task.

Therefore, there is a need for a system and method for rapid presentation of historical views of stored data.

### SUMMARY OF THE INVENTION

The present invention provides a system and method for rapid presentation of historical views. In a method according to some embodiments, a request for a historical view of stored data is received. An index that indicates the location of at least one data block copy in a storage medium that correlates with the historical view is accessed and the at least one data block copy from the storage medium is retrieved. The historical view of the stored data is then generated from the at least one data block copy.

### BRIEF DESCRIPTION OF THE DRAWINGS

FIG. 1 shows a schematic illustration of an exemplary environment for copying and storing data for rapid presentation of historical views;

FIG. 2 shows a schematic diagram for exemplary recovery server coordination of historical views;

FIG. 3 shows a schematic diagram for an exemplary environment for rapid presentation of historical views;

FIG. 4 shows an exemplary environment for modification to historical views; and

FIG. 5 shows a flow diagram illustrating an exemplary process for rapid presentation of historical views.

### DESCRIPTION OF EXEMPLARY EMBODIMENTS

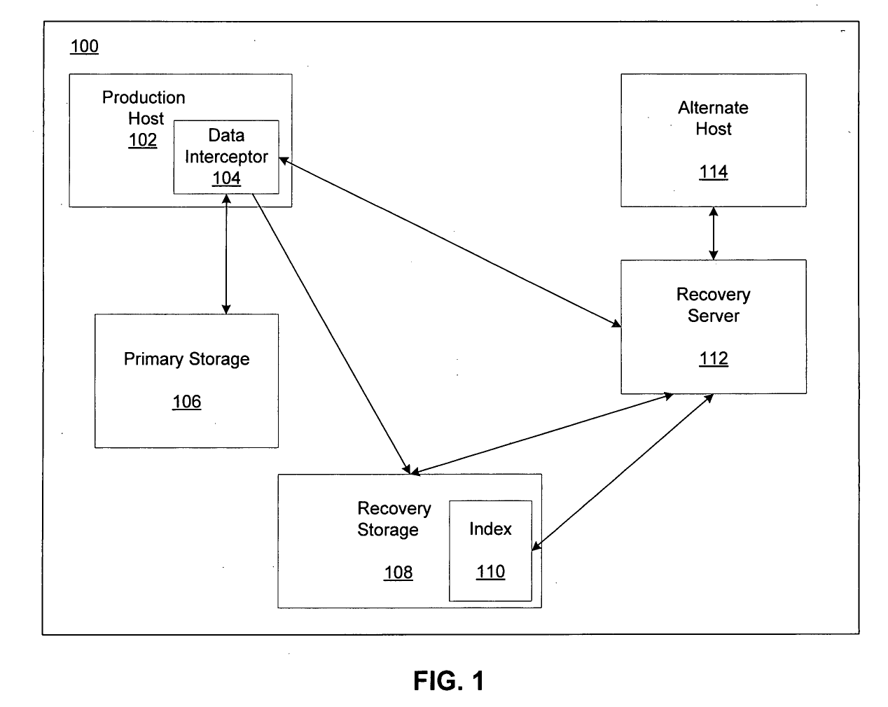

FIG. 1 is a schematic diagram of an environment for copying and storing data for rapid presentation of historical views in accordance with exemplary embodiments. Fibre Channel (FC) may be utilized to transmit data between the components shown in FIG. 1. However, any type of system (e.g., optical system), in conjunction with FC or alone, may be utilized for transmitting the data between the components.

The exemplary environment 100 comprises a production host 102 for creating various types of data. For example, a financial software program running on the production host 102 can generate checkbook balancing data. Any type of data may be generated by the production host 102. Further, the production host 102 may include any type of computing device, such as a desktop computer, a laptop, a server, a personal digital assistant (PDA), and a cellular telephone. In a further embodiment, a plurality of production hosts 102 may be provided.

The production host 102 may include a data tap 104. The data tap 104 may be any hardware, software, or firmware that resides on the production host 102, or otherwise accesses the data generated by the production host 102. For example, the data tap 104 may be embedded in a SAN switch or a disk array controller. According to exemplary embodiments, the data tap 104 may be coupled to, or reside on, one or more production hosts 102. Conversely, in some embodiments, the production host 102 may include or be coupled to more than one data tap 104.

The data tap 104 copies data created by the production host 102 and stores the data (“data blocks”) in a primary storage 106 associated with the production host 102. The copies of the data blocks (“data block copies”) are stored to recovery storage 108. The recovery storage 108 may comprise any type of storage, such as time addressable block storage (“TABS”). Although “data blocks” and “data block copies” is utilized to describe the data created and the copies of the data generated, files, file segments, data strings and any other data may be created and copies generated according to various embodiments. Further, the data blocks and the data block copies may be a fixed size or varying sizes.

The primary storage 106 and/or the recovery storage 108 may include random access memory (RAM), hard drive memory, a combination of static and dynamic memories, or any other memory resident on the production host 102 or coupled to the production host 102. The primary storage 106 may include any storage medium coupled to the production host 102 or residing on the production host 102. In one embodiment, the data tap 104 may store the data blocks to more than one of the primary storage 106.

According to one embodiment, the data tap 104 can create data block copies from the data blocks after the production host 102 stores the data blocks to the primary storage 106 or as the data blocks are generated by the production host 102.

Data blocks are typically created from the production host 102 each instant a change to existing data at the primary storage 106 is made. Accordingly, a data block copy may be generated each time the data block is generated, according to exemplary embodiments. In another embodiment, the data block copy may comprise more than one data block. Each data block copy and/or data block may reflect a change in the overall data comprised of the various data blocks in the primary storage 106.

In exemplary embodiments, the data tap 104 intercepts each of the data blocks generated by the production host 102 in order to create the data block copies. The data block is sent to the primary storage 106 by the data tap 104, while the data tap 104 sends the data block copy to the recovery storage 108, as discussed herein. The data block copies may be combined to present a view of data at a recovery point (i.e., as the data existed at a point in time), called a “historical view.” In other words, the data block copies may be utilized to recreate the data (i.e., the data blocks stored in the primary storage 106) as it existed at a particular point in time. The “historical view” of the data may be provided to a user requesting the data as a “snapshot” of the data. The snapshot may comprise an image of the data block copies utilized to create the historical view, according to one embodiment.

In an alternative embodiment, the data tap 104, or any other device, may compare the data blocks being generated with the data blocks already stored in the primary storage 106 to determine whether changes have occurred. The copies of the data blocks may only be generated when changes are detected.

The historical view may also be used to present an image of all of the data in the primary storage 106 utilizing some of the data block copies in the recovery storage 108 and some of the data blocks in the primary storage 106. In other words, the historical view at time x may comprise all of the data in the primary storage 106 and/or the recovery storage 108. In some embodiments, the data block copies from the recovery storage 108 may be combined with the data blocks from the primary storage 106 in order to create the historical view. Accordingly, the historical view may be comprised of data blocks from the primary storage 106 and data block copies from the recovery storage 108 with both the data blocks and the data block copies contributing to the overall historical view.

In one embodiment, the production host 102 reserves private storage or temporary storage space for the data tap 104. The private storage space may be utilized by the data tap 104 for recording notes related to the data blocks, for temporarily storing the data block copies, or for any other purpose. For instance, if the recovery server 112 is not available to instruct the data tap 104 where to store the data block copies in the recovery storage 108, the temporary storage may be utilized to store the data block copies until the recovery server 112 is available.

Similarly, the temporary storage may be utilized to store the data block copies if the recovery storage 108 is unavailable. Once the recovery server 112 and/or the recovery storage 108 is once again available, the data block copies may then be moved from the temporary storage to the recovery storage 108 or any other storage.

In another embodiment, the data tap 104, using a bit map or any other method, tracks the data blocks from the production host 102 that change. Accordingly, if the recovery server 112 and/or the recovery storage 108 is unavailable, the data tap 104 records which blocks on the primary'storage 106 change. The data tap 104 can copy only the data blocks from the primary storage 106 to the recovery storage 108 that changed while the recovery server 112 and/or the recovery storage 108 were unavailable. Specifically, the data tap 104 or any other device flags each data block generated by the production host 102 that changes. The flags are referenced when the recovery server 112 and/or the recovery storage 108 are available to determine which data blocks were changed during the time the recovery server 112 and/or the recovery storage 108 were unavailable. Although each data block may change more than one time, each of the data blocks reflecting the most recent change to the data blocks when the recovery server 112 and/or the recovery storage 108 become available are the data blocks that are copied to the recovery storage 108 from the primary storage 106.

In yet another embodiment, the data tap 104 may continue to store the data block copies to an area of the recovery storage 108 allocated for data block copies from the data tap 104 by the recovery server 112 prior to the recovery server 112 becoming unavailable. In other words, if the recovery server 112 is unavailable, but the recovery server 112 has previously instructed the data tap 104 to store the data block copies to a specified area of the recovery storage 108, the data tap 104 can continue to store the data block copies to the specified area until the specified area is full and/or the recovery server 112 becomes available.

In still a further embodiment, a back-up recovery server may be provided to provide the recovery server 112 functions if the recovery server 112 is unavailable. As discussed herein, more than one recovery server 112 may be provided. Similarly, more than one production host 102 may be provided, as a set of computing devices or other configuration, with other production hosts 102 capable of performing functions associated with the production host 102 in the event the production host 102 becomes unavailable. The process of restoring data is described in further detail in co-pending U.S. application Ser. No. ______, entitled “Systems and Methods of Optimizing Restoration of Stored Data,” filed on Aug. 30, 2005.

The exemplary data tap 104 also creates metadata in one or more “envelopes” to describe the data block copies and/or the data blocks. The envelopes may include any type of metadata. In exemplary embodiments, the envelopes include metadata describing the location of the data block in the primary storage 106 (i.e., a logical block address “LBA”), the size of the data block and/or the data block copies, the location of the data block copy in the recovery storage 108, or any other information related to the data. In exemplary embodiments, the envelopes associated with the data block copies preserve the order in which the data blocks are created by including information about the order of data block creation by the production host 102. The protocol for communicating data block copies is described in further detail in co-pending U.S. application Ser. No. ______, entitled “Protocol for Communicating Data Block Copies in an Error Recovery Environment,” filed on Aug. 30, 2005.

The data tap 104 forwards the envelopes to a recovery server 112. The data tap 104 may associate one or more unique identifiers, such as a snapshot identifier (“SSID”), with the data block copies to include with one or more of the envelopes. Alternatively, any device can associate the unique identifiers with the one or more envelopes, including the data tap 104. The recovery server 112 may also designate areas of the recovery storage 108 for storing one or more of the data block copies in the recovery storage 108 associated with the one or more envelopes. When the data tap 104 stores the data block copies to the recovery storage 108, the data tap 104 can specify in the associated envelopes where the data block copy was stored in the recovery storage 108. Alternatively, any device can designate the physical address for storing the data block copies in the recovery storage 108.

The unique identifiers may be assigned to single data block copies or to a grouping of data block copies. For example, the recovery server 112 or other device can assign the identifier to each data block copy after the data block copy is created by the data tap 104, or the unique identifier may be assigned to a group of the data block copies.

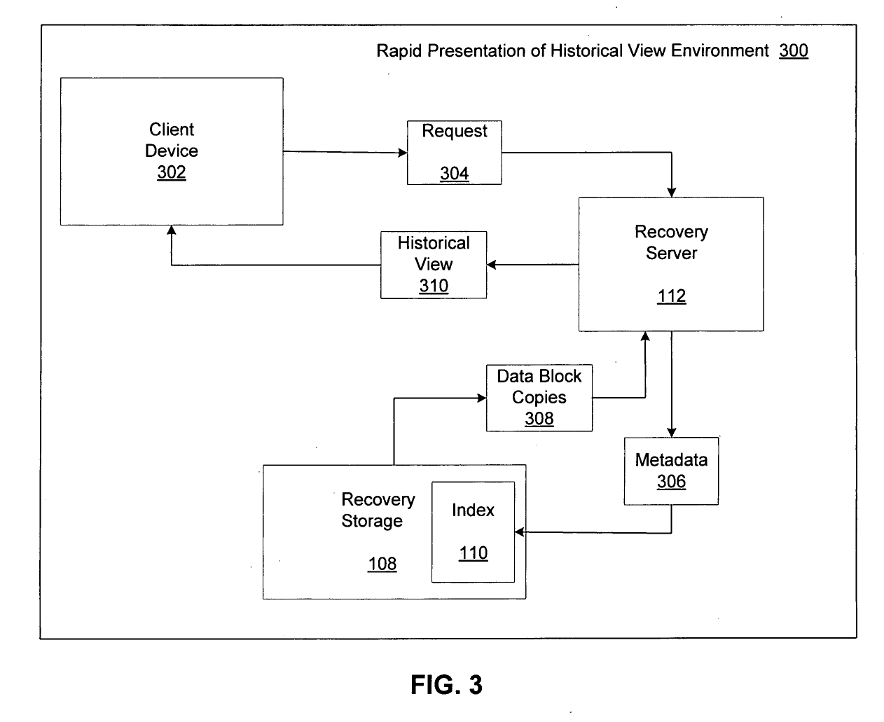

The recovery server 112 uses the envelopes to create a recovery index (discussed infra in association with FIG. 3). The recovery server 112 then copies the recovery index to the recovery storage 108 as an index 110. The index 110 maps the envelopes to the data block copies in the recovery storage 108. Specifically, the index 110 maps unique identifiers, such as addresses or sequence numbers, to the data block copies using the information included in the envelopes. In alternative embodiments, the index 110 may be stored in other storage mediums or memory devices coupled to the recovery storage 108 or any other device.

In exemplary embodiments, the data tap 104 forwards the data block copies and the envelope(s) to the recovery storage 108. The recovery storage 108 may include the index 110, or the index 110 may otherwise be coupled to the recovery storage 108. More than one recovery storage 108 and/or indexes 110 may be utilized to store the data block copies and the envelope(s) for one or more production hosts 102 according to various embodiments. Further, the recovery storage 108 may comprise random access memory (RAM), hard drive memory, a combination of static and dynamic memories, direct access storage devices (DASD), or any other memory. The recovery storage 108 and/or the index 110 may comprise storage area network (SAN)-attached storage, a network-attached storage (NAS) system, or any other system or network.

The unique identifiers, discussed herein, may be utilized to locate each of the data block copies in the recovery storage 108 from the index 110. As discussed herein, the index 110 maps the envelopes to the data block copies according to the information included in the envelopes, such as the unique identifier, the physical address of the data block copies in the recovery storage 108, and/or the LBA of the data blocks in the primary storage 106 that correspond to the data block copies in the recovery storage 108. Accordingly, the recovery server 112 can utilize a sort function in coordination with the unique identifier, such as a physical address sort function, an LBA sort function, or any other sort function to locate the data block copies in the recovery storage 108 from the map provided in the index 110.

The recovery server 112 is also coupled to the recovery storage 108 and the index 110. In an alternative embodiment, the recovery server 112 may instruct the data tap 104 on how to create the index 110 utilizing the envelopes. The recovery server 112 may communicate any other instructions to the data tap 104 related to the data blocks, the data block copies, the envelope(s), or any other matters. Further, the recovery server 112 may be coupled to more than one recovery storage 108 and/or indexes 110.

As discussed herein, the index 110 may be utilized to locate the data block copies in the recovery storage 108 and/or the data blocks in the primary storage 106. Any type of information may be included in the envelope(s), such as a timestamp, a logical unit number (LUN), a logical block address (LBA), access and use of data being written for the data block, a storage media, an event associated with the data block, a sequence number associated with the data block, an identifier for a group of data block copies stemming from a historical view of the data, and so on.

In one embodiment, the envelopes are indexed according to the metadata in the envelopes, which may be utilized as keys. For example, a logical address index may map logical addresses found on the primary storage 106 to the data block copies in the recovery storage 108. A physical address index may map each physical data block copy address in the recovery storage 108 to the logical address of the data block on the primary storage 106. Additional indexing based on other payload information in the envelopes, such as snapshot identifiers, sequence numbers, and so on are also within the scope of various embodiments. One or more of the indexes may be provided for mapping and organizing the data block copies.

One or more alternate hosts 114 may access the recovery server 112. In exemplary embodiments, the alternate hosts 114 may request data as it existed at a specific point in time or the recovery point (i.e. the historical view of the data) on the primary storage 106. In other words, the alternate host 114 may request, from the recovery server 112, data block copies that reveal the state of the data as it existed at the recovery point (i.e., prior to changes or overwrites to the data by further data blocks and data block copies subsequent to the recovery point). The recovery server 112 can provide the historical view of the data as one or more snapshots to the alternate hosts 114, as discussed herein.

The alternate hosts 114, or any other device requesting and receiving restored data, can utilize the historical view to generate new data. The new data can be saved and stored to the recovery storage 108 and/or referenced in the index 110. The new data may be designated by users at the alternate hosts 114 as data that should be saved to the recovery storage 108 for access by other users. The recovery server 112 may create envelopes to associate with the new data and store the envelopes in the index 110 in order to organize and map the new data in relation to the other data block copies already referenced in the index 110. Accordingly, the alternate hosts 114 or other device can create various new data utilizing the historical views as the basis for the various new data.

The recovery server 112 may manage the storing of data within the recovery storage 108 and/or the index 110. For example, the user of a historical view may make changes and alter the data associated with the historical view. In some embodiments, the recovery storage 108 will receive copies and store the changes without deleting or overwriting existing data. In other embodiments, the recovery server 112 can manage the space in the recovery storage 108 by freeing up data blocks for reuse or overwrites. As a result of the management of data storage, space within the recovery storage 108 may be used more efficiently thereby allowing the recovery storage 108 to store additional data. The user or the recovery server 112 may determine which points in time or event markers are selected for the overwrites. Similarly, the user or the recovery server 112 may determine which branches of the branching tree can be selected to overwrite data. In another example, whenever data is overwritten in the recovery storage 108, the recovery server 112 may create an event marker.

Each of the alternate hosts 114 may include one or more data taps 104 according to one embodiment. In another embodiment, a single data tap 104 may be coupled to one or more of the alternate hosts 114. In yet a further embodiment, the data tap 104 functions may be provided by the recovery server 112.

An interface may be provided for receiving requests from the alternate host 114. For instance, a user at the alternate host 114 may select a recovery point for the data from a drop down menu, a text box, and so forth. In one embodiment, the recovery server 112 recommends data at a point in time that the recovery server 112 determines is ideal given parameters entered by a user at the alternate host 114. However, any server or other device may recommend recovery points to the alternate host 114 or any other device. Predetermined parameters may also be utilized for requesting recovered data and/or suggesting optimized recovery points. Any type of variables may be considered by the recovery server 112 in providing a recommendation to the alternate host 114 related to data recovery.

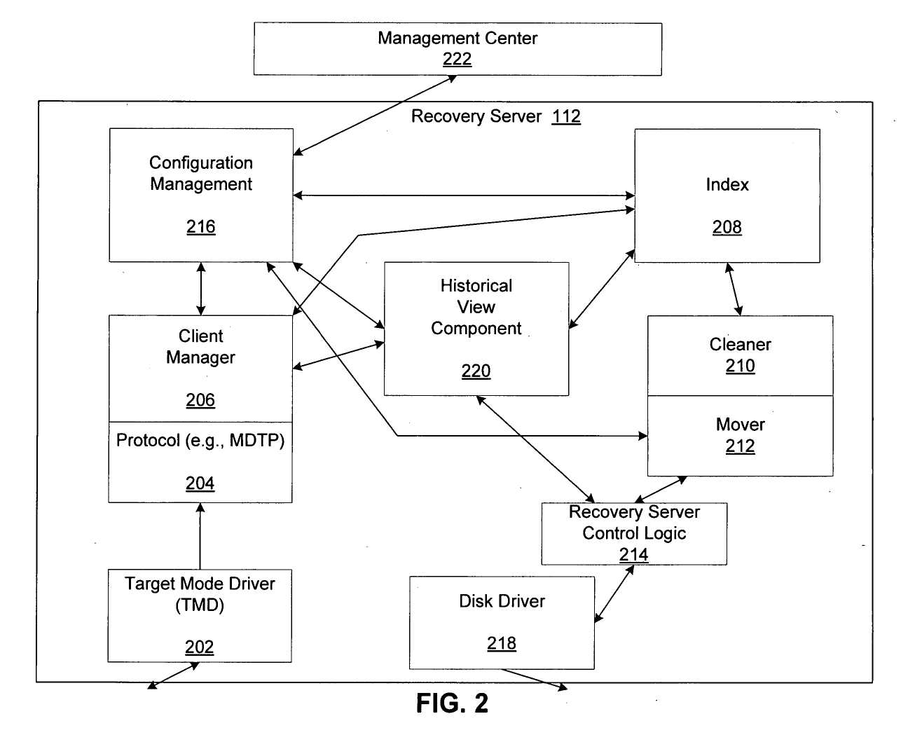

FIG. 2 shows an exemplary schematic diagram for recovery server 112 coordination of historical views. One or more envelopes arrive at the recovery server 112 via a target mode driver (TMD) 202. The TMD 202 responds to commands for forwarding the envelopes. Alternatively, any type of driver may be utilized for communicating the envelopes to the recovery server 112.

The envelopes may be forwarded by the data interceptor 104 utilizing a proprietary protocol 204, such as the Mendocino Data Tap Protocol (MDTP). A client manager 206 may be provided for coordinating the activities of the recovery server 112. The envelopes are utilized by the recovery server 112 to construct a recovery index 208. The recovery index 208 is then copied to the index 110 (FIG. 1) associated with the recovery storage 108 (FIG. 1). In order to update the index 110, the recovery index 208 may be updated and copied each time new envelopes arrive at the recovery server 112 or the recovery server 112 may update the index 110 with the new envelope information at any other time.

Optionally, a cleaner 210 defragments the data block copies and any other data that is stored in the recovery storage 108. As another option, a mover 212 moves the data block copies (i.e. the snapshots) in the recovery storage 108 and can participate in moving the data block copies between the recovery storage 108, the production host 102, the alternate hosts 114 (FIG. 1), and/or any other devices.

Recovery storage control logic 214 manages storage of the envelopes and the data block copies in the recovery storage 108 using configuration information generated by a configuration management component 216. A disk driver 218 then stores (e.g., writes) the envelopes and the data block copies to the recovery storage 108.

When a user requests a historical view of the data, as discussed herein, a historical view component 220 retrieves the data block copies needed to provide the historical view requested by a user. The user may request the historical view based on an event marker or any other criteria. Specifically, the historical view component 220 references the recovery index 208 or the index 110 pointing to the data block copies in the recovery storage 108. The historical view component 220 then requests the data block copies, corresponding to the envelopes in the index 110, from the recovery storage control logic 214. The disk driver 218 reads the data block copies from the recovery storage 108 and provides the data block copies to the historical view component 220. The data block copies are then provided to the user at the alternate host 114 that requested the data.

As discussed herein, according to one embodiment, the historical view may be constructed utilizing the data block copies from the recovery storage 108 and the data blocks from the primary storage 106. Thus, the data block copies may be utilized to construct a portion of the historical view while the data blocks may be utilized to construct a remaining portion of the historical view.

The user of the historical view may utilize the historical view to generate additional data blocks, as discussed herein. Copies of the data blocks may then be stored in the recovery storage 108 along with corresponding envelopes. The recovery server 112 then updates the index 110 to include references to the new data block copies. Accordingly, the new data block copies are tracked via the index 110 in relation to other data block copies already stored in the recovery storage 108. One or more event markers may be associated with the new data block copies, as the copies are generated or at any other time. As discussed herein, the event markers may be directly associated with the new data block copies, or they event markers may be indirectly associated with the new data block copies. According to some embodiments, generating the new data block copies constitutes an event to associate with an event marker, itself.

A branching data structure that references the index 110 may be provided. The branching data structure can indicate a relationship between original data and modifications that are stored along with the original data upon which those modifications are based. Modifications can continue to be stored as the modifications relate to the data upon which the modifications are based, so that a hierarchical relationship is organized and mapped. By using the branching data structure, the various data block copies relationship to one another can be organized at a higher level than the index 110. The branching data structure and the index 110 may comprise a single structure according to some embodiments. According to further embodiments, the branching data structure, the index 110, and/or the data block copies may comprise a single structure.

The branches in the branching data structure may be created when the historical views are modified, or when data blocks from the primary storage 106 are removed or rolled back to a point in time (i.e. historical view). Event markers may be inserted on the branches after the branches are generated. The data interceptor 104 functionality, as discussed herein, may be provided by any components or devices.

In some embodiments, a historical view component, such as the historical view component 220 discussed herein, residing at the recovery server 112 may provide historical views to an alternate server, such as the alternate host 114 discussed herein or any other device. The alternate server may then utilize the historical view to generate additional data blocks. For example, the alternate server may write data on top of the historical view. The additional data blocks may be generated by the alternate server using the historical view component at the recovery server 112. The historical view component 220 may then generate envelopes and store the envelopes and the data blocks in the recovery server 112, as well as update the index 110 accordingly. Thus, the historical view component 220 in some embodiments provides functions similar to the functions that may be provided by the data interceptor 104. In other embodiments, the historical view component 220 resides outside of the recovery server 112, but is coupled to the recovery server 112 and the recovery storage 108 in order to provide functionalities similar to the data interceptor 104. Further, the production host 102 and the alternate server may comprise a single device according to some embodiments. As discussed herein, the primary storage 106 and the recovery storage 108 may comprise one storage medium according to some embodiments.

In other embodiments, the production host 102 includes the historical view component 220 and a data interceptor 104, both residing on the production host 102. However, the historical view component 220 and/or the data interceptor 104 may reside outside of, but be coupled to, the production host 102 in other embodiments. Further, the historical view component 220 and the data interceptor 104 may comprise one component in some embodiments. The generation of envelopes, data blocks, data block copies, indexes, and so forth may be performed by the historical view component 220 and/or the data interceptor 104 at the production host 102 in such an embodiment.

As discussed herein, the historical view component 220 may request data blocks from the primary storage 106 and/or data block copies from the recovery storage 108 in order to generate the historical view. Further, the additional data blocks generated utilizing the historical view (i.e. on top of the historical view) may be stored to either the primary storage 106, the recovery storage 108, or to both the primary storage 106 and the recovery storage 108. The primary storage and the recovery storage may be combined into one unified storage in some embodiments.

A management center 222 may also be provided for coordinating the activities of one or more recovery servers 112, according to one embodiment.

Although FIG. 2 shows the recovery server 112 having various components, the recovery server 112 may include more components or fewer components than those listed and still fall within the scope of various embodiments.

Referring to FIG. 3, a schematic diagram for an exemplary environment for rapid presentation of historical views is shown. A client device 302 generates a request 304 for a historical view. The client device 302 may include any computing device, such as the production host 102, the alternate host 114, a server device, and so forth. A user at the client device 302 submits the request 304 for the historical view. As discussed herein, the historical view comprises a state of data at any point in time. The historical view request may include an event marker specification or any other details that may help to define the historical view being requested.

The recovery server 112 receives the request 304 from the client device 302 and determines which data block copies may be utilized to construct the historical view of the data. As discussed herein, the data block copies may be combined with the actual data blocks to generate the historical view. The data block copies and the data blocks may both reside in the recovery storage 108 or the data blocks may reside separately from the data block copies (i.e., in the primary storage 106). The recovery server 108 locates and utilizes metadata 306 to locate pointers in the index 110 that indicate the location of the data block copies needed for the historical view in the recovery storage 108.

The recovery storage 108 retrieves the data block copies from the recovery storage 108 and assembles them into the historical view of the stored data, as requested by the user at the client device 302. For example, the data block copies may need to be formatted according to an operating system associated with the client device 302.

The recovery server 108 then presents the historical view 310 to the client 302. Any type of manner for presenting the historical view 310 to the user is within the scope of various embodiments. Further, the same historical view 310 can be presented to more than one user simultaneously. The historical view 310 comprises the combination of data block copies and/or data blocks that represent the state of data at any point in time. Thus, the same historical view 310 can be presented indefinitely. Accordingly, the historical view 310 can be modified by one or more users and the original historical view 310 presented to those one or more users to modify remains available. When the historical view is presented to multiple users, the changes to the historical views made by each user may be tracked separately such that the changes made by one are visible to only that user. When the historical view is presented to a cluster of computers which share the view, the changes made all of them may be tracked collectively such that the changes made any of the membes of the cluster are visible and available to all of the members of the cluster.

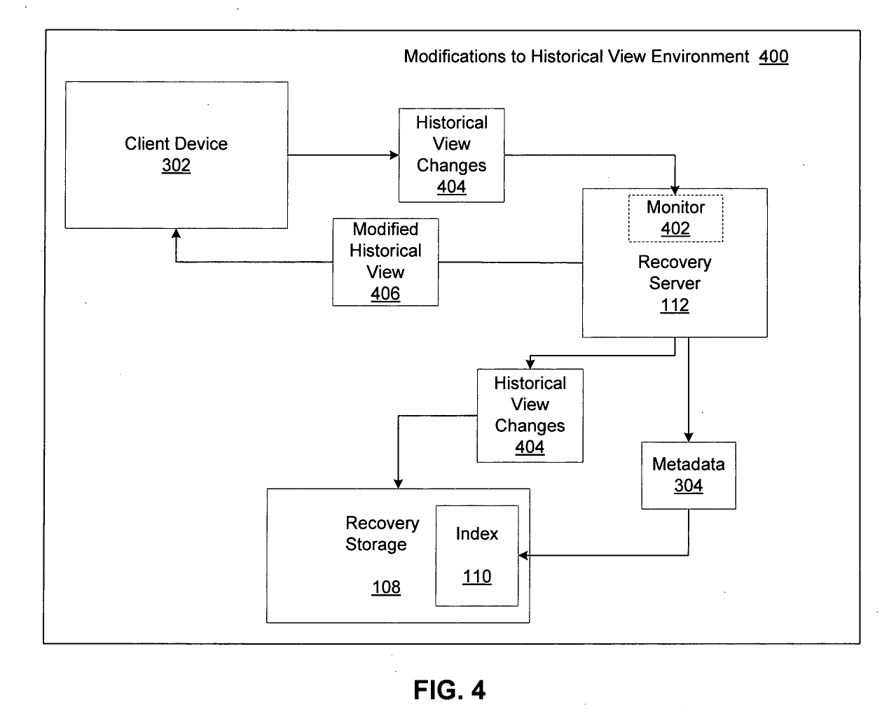

FIG. 4 shows a schematic diagram for an exemplary environment for modifications to historical views. The recovery server 112 may include a monitor 402 for detecting changes to the historical view 310 from the client device 302. According to some embodiments, the data interceptor 104 discussed in FIG. 1 may reside on the client device 302 or be coupled to the client device 302 for detecting historical view changes 404. Any device or component can be provided for detecting the historical view changes 404.

When changes are detected, the historical view changes 404 are retrieved by the recovery server 112. Alternatively, once the user at the client 302 receives the historical view 310, the client can forward the historical view changes 404 to the recovery server 112.

The recovery server 112 generates metadata 304 for the historical view changes 404. The metadata 304 may be provided by the data interceptor 102 and/or the client device 302 according to some embodiments. The metadata 304 updates the index 110 with the location of the historical view changes 404 in the recovery storage 108. The updates to the index may result in a branching tree structure, allowing the user to view historical views of the changes to earlier historical views themselves. Event markers may also be inserted in the course of accessing the historical views. Branching tree structures and the process of generating event markers is described in further detail in co-pending U.S. application Ser. No. ______, entitled “Systems and Methods for Organizing and Mapping Data,” filed on Jun. 23, 2005, and co-pending U.S. application Ser. No. ______, entitled “Systems and Methods for Event Driven Recovery Management,” filed on Aug. 30, 2005.

The historical view changes 404 comprise data block copies and/or data blocks that indicate additions to or deletions from the historical view 310 presented to the user. Although the historical view 310 may be modified by the user, as discussed herein, the original historical view 310 can be provided since the historical view is constructed from one or more data block copies and/or one or more data blocks that are consistently maintained in the recovery storage 108, the primary storage 106, and/or any other storage medium.

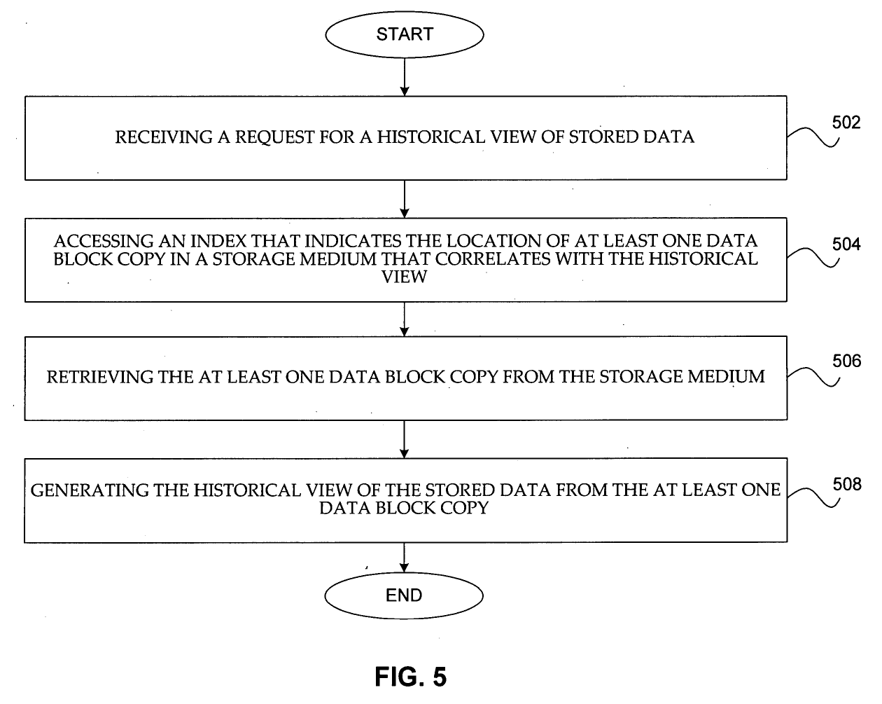

Turning now to FIG. 5, a flow diagram illustrating an exemplary process for rapidly presenting historical views is shown. At step 502, a request for a historical view of stored data is received. The request may be received from the alternate host 114 (FIG. 1), the production host 102, the client device 302, or any other device. The historical view may be comprised of data block copies that reflect the state of the data at any point in time, as discussed herein, which may be specified by the user according to the point in time, according to events, according to a state of the data when the data coordinated with an external source, such as an application, and so forth. Any type of information may be provided for defining or further defining the historical view the user desires.

At step 504, an index that indicates the location of at least one data block copy in a storage medium that correlates with the historical view is accessed. For example, the index 110 may indicate the location of data block copies in the recovery storage 108 that will be needed to construct the historical view, as discussed herein. In some embodiments, the storage medium may comprise the primary storage 106. In exemplary embodiments, the at least one data block copy may comprise the data block copies and/or the data blocks. Accordingly, the historical view may be comprised of both the data block copies and the data blocks. The index 110 may be located at the recovery server 112, the recovery storage 108, or both.

The at least one data block copy is retrieved from the storage medium at step 506. The data block copies that are retrieved are the data block copies needed to construct the historical view of the data as it existed at the point in time specified by a user making the request (see step 402). The historical view component 220 (FIG. 2) may retrieve the data block copies via the recovery server control logic 214 (FIG. 2) and/or the disk driver 218 (FIG. 2).

At step 508, the historical view of the stored data is generated from the at least one data block copy. The recovery server 112 assembles the data block copies for the historical view to look like data that has been backed-up to the point in time specified by the user. By identifying the data block copies and/or the data blocks required for the historical view and assembling them into the historical view, the historical view of the data as it existed at the point in time specified by the user may be presented to the user without backing up the data in the primary storage 106 and/or recovery storage 108. Further, any user can make modifications to the historical view presented, which may be presented simultaneously to other users and indefinitely because the data block copies are available to construct the historical view. The historical view may be formatted according to operating system requirements associated with a computing device of a user, such as the production host 102, the alternate host 114, the client device 302, or any other device.

While various embodiments have been described above, it should be understood that they have been presented by way of example only, and not limitation. For example, any of the elements associated with the rapid presentation of historical views of stored data may employ any of the desired functionality set forth hereinabove. Thus, the breadth and scope of a preferred embodiment should not be limited by any of the above-described exemplary embodiments.

What is claimed is:

1. A method for providing rapid presentation of historical views of stored data comprising:
receiving a request for a historical view of stored data;
accessing an index that indicates the location of at least one data block copy in a storage medium that correlates with the historical view;
retrieving the at least one data block copy from the storage medium; and
generating the historical view of the stored data from the at least one data block copy.

2. The method recited in claim 1, wherein generating the historical view of the stored data from the at least one data block copy further includes at least one data block from the storage medium.

3. The method recited in claim 1, wherein generating the historical view of the stored data from the at least one data block copy further includes at least one data block from a primary storage.

4. The method recited in claim 1, wherein the at least one data block copy comprises various sizes of data.

5. The method recited in claim 1, further comprising presenting the historical view to a user.

6. The method recited in claim 5, further comprising allowing the user to modify the historical view.

7. The method recited in claim 6, further comprising maintaining the historical view presented to the user without the modifications and the historical view presented to the user with any modifications made by the user.

8. The method recited in claim 1, further comprising presenting the same historical view to one or more users simultaneously.

9. The method recited in claim 1, wherein the historical view comprises a state of data at any point in time.

10. The method recited in claim 8, wherein the request for the historical view comprises a specified event marker.

11. The method recited in claim 1, further comprising formatting the historical view according to operating system requirements associated with a computing device of a user.

12. A system for providing rapid presentation of historical views of stored data comprising:
a server configured to receive a request for a historical view of stored data;
an index coupled to the server configured to indicate the location of at least one data block copy in a storage medium that correlates with the historical view; and
a historical view component coupled to the server configured to retrieve the at least one data block copy from the storage medium and to generate the historical view of the stored data from the at least one data block copy.

13. The system recited in claim 12, wherein the historical view component is further configured to retrieve at least one data block from the storage medium and to generate the historical view of the stored data from the at least one data block copy and the at least one data block.

14. The system recited in claim 12, wherein the historical view component is further configured to retrieve at least one data block from a primary storage and to generate the historical view of the stored data from the at least one data block copy and the at least one data block.

15. The system recited in claim 12, wherein the at least one data block copy comprises various sizes of data.

16. The system recited in claim 12, wherein the server is further configured to present the historical view to a user.

17. The system recited in claim 16, wherein the server is further configured to allow the user to modify the historical view.

18. The system recited in claim 17, wherein the server is further configured to maintain the historical view presented to the user without the modifications and the historical view presented to the user with any modifications made by the user.

19. The system recited in claim 12, wherein the server is further configured to present the same historical view to one or more users simultaneously.

20. The system recited in claim 11, wherein the historical view comprises a state of data at any point in time.

21. The system recited in claim 20, wherein the request for the historical view comprises a specified event marker.

22. The system recited in claim 11, wherein the server is further configured to format the historical view according to operating system requirements associated with a computing device of a user.

23. A computer program embodied on a computer readable medium for providing rapid presentation of historical views of stored data comprising:
receiving a request for a historical view of stored data;
accessing an index that indicates the location of at least one data block copy in a storage medium that correlates with the historical view;
retrieving the at least one data block copy from the storage medium; and
generating the historical view of the stored data from the at least one data block copy.

24. The computer program recited in claim 23, wherein generating the historical view of the stored data from the at least one data block copy further includes at least one data block from the storage medium.

25. The computer program recited in claim 23, wherein generating the historical view of the stored data from the at least one data block copy further includes at least one data block from a primary storage.

26. The computer program recited in claim 23, wherein the at least one data block copy comprises various sizes of data.

27. The computer program recited in claim 23, further comprising presenting the historical view to a user.

28. The computer program recited in claim 27, further comprising allowing the user to modify the historical view.

29. The computer program recited in claim 28, further comprising maintaining the historical view presented to the user without the modifications and the historical view presented to the user with any modifications made by the user.

30. The computer program recited in claim 23, further comprising presenting the same historical view to one or more users simultaneously.

31. The computer program recited in claim 23, wherein the historical view comprises a state of data at any point in time.

32. The computer program recited in claim 30, wherein the request for the historical view comprises a specified event marker.

33. The computer program recited in claim 23, further comprising formatting the historical view according to operating system requirements associated with a computing device of a user.
